(19) United States
(12) Patent Application Publication
(10) Pub. No.: US 2010/0330488 A1
(43) Pub. Date: Dec. 30, 2010

(54) POSITIVELY-CHARGEABLE TONER FOR DEVELOPING ELECTROSTATIC IMAGES

(75) Inventor: Osamu Ieda, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ZEON CORPORATION, Tokyo-to (JP)

(21) Appl. No.: 12/676,993

(22) PCT Filed: Sep. 26, 2008
(86) PCT No.: PCT/JP2008/067548

§ 371 Date: Mar. 8, 2010

(30) Foreign Application Priority Data
Sep. 29, 2007 (JP) 2007-256948

(51) Int. Cl. G03G 13/08; G03G 9/08; G03G 9/087; G03G 9/09

(52) U.S. Cl. 430/108.4; 430/108.7; 430/123.51

(57) ABSTRACT

The present invention is to provide a positively-chargeable toner for developing electrostatic images, which is excellent in reproductivity of thin lines and in durability and has a stable charging ability and flowability over time. A positively-chargeable toner comprises a colored resin particle and external additives, wherein a spherical colloidal silica particle having a number average primary particle diameter of 30 to 80 nm and a triboelectric charge amount of −50 to +300 μC/g, and a fumed silica particle having a number average primary particle diameter of 5 to 25 nm are contained as the external additives, and wherein a content of the spherical colloidal silica particle is in the range from 0.3 to 2 parts by weight and a content of the fumed silica particle is in the range from 0.1 to 1 parts by weight with respect to 100 parts by weight of the colored resin particle.

### TECHNICAL FIELD

The present invention relates to a positively-chargeable toner for developing electrostatic images (hereinafter, it may be simply referred to as “positively-chargeable toner” or “toner”) used for development of latent electrostatic images in electrophotography, the electrostatic recording method, the electrostatic printing process or the like. Particularly, the present invention relates to a positively-chargeable toner for developing electrostatic images which is applicable to a toner replenishment-type image forming device.

### BACKGROUND ART

Image-forming devices such as electrophotographic devices, electrostatic recording devices, electrostatic printing devices, and so on are applied to copying machines, printers, facsimile machines, complex machines thereof and so on. An image-forming method of forming a desired image by developing an electrostatic latent image formed on a photosensitive member with a toner for developing an electrostatic image is widely employed.

For example, an electrophotographic device using electrophotography uniformly charges the surface of a photosensitive member generally formed of photoconductive material with any of various means, and then, an electrostatic latent image is formed on the photosensitive member. Next, the electrostatic latent image is developed using a toner. After transferring an image of the toner on a recording material such as paper or the like, the image is fixed by heating or the like. Thus, a copy is obtained. Further, the toner which is remained on the photosensitive member after transfer (residual toner after transfer) is subjected to cleaning by various methods, and the above steps are repeated.

As a means for cleaning, a blade cleaning means comprising a cleaning blade generally made of a rubber elastic body, wherein the cleaning blade is pressed on the photosensitive member, is widely used.

As toners used for the image forming device, there are a negatively-chargeable toner and a positively-chargeable toner. In recent years, the positively-chargeable toner is preferably used from the viewpoint of inhibiting ozone generation and obtaining the toner excellent in charging ability.

In addition, external additives such as inorganic particles and organic particles having smaller particle diameter than that of toner particles are attached by addition (externally added) on the surface of the toner particles used for the image forming device for the purpose of imparting functions such as charging ability, flowability, durability and cleaning ability.

However, even if microparticles of the external additive are uniformly attached on the surface of the toner particles before the toner is supplied to the image forming device or in the early stage of printing, defects such that microparticles of the external additive are buried on and/or released (detached) from the surface of toner particles are likely to occur due to mechanical stress in a development device in the process of continuous printing of a large number of images. Thus, it has been a problem that functions as external additives decrease and deterioration of image quality due to fog or the like occurs to decrease the reproductivity of thin lines, and adverse effect on printing performance is caused.

Accordingly, development of a toner having excellent durability is demanded, wherein, in the process of continuous printing of a large number of prints, defects such as burial and/or release of the microparticles of the external additive are less likely to occur, the toner can maintain the state in which microparticles of the external additive are uniformly and suitably attached to the surface of the toner particles over time, functions of the external additive such as charging ability, flowability and durability, which are imparted to the toner particles, are not decreased, and fog is hardly caused so that the toner has high-quality printing performance such as reproductivity of thin lines.

If the above toner is developed, such a toner is applicable to replenishment-type image forming devices.

Conventional image forming devices employ a replacement system, wherein a whole cartridge is replaced to a new one when the amount of toner becomes small after continuous printing of a large number of prints. However, development of a toner also applicable to an image forming device which can newly replenish the toner left in small amount (remaining toner) with a toner (new toner) is desired as requested from the viewpoint of environment and cost of the replenishment-type image forming devices.

It has been a problem in the development of the toner also applicable to the replenishment-type image forming devices that since toner particles having different charging state mix when the remaining toner is replenished with a new toner and charge change is caused, replenishment of the remaining toner with a new toner has adverse effect on printing performance that the initial charging speed may decrease upon initial printing soon after replenishment of the toner so that a large number of prints are required to be able to print without fog.

Patent Literature 1 discloses a negatively-chargeable toner obtained by using 0.01 to 20 parts by weight of a hydrophobic spherical silica particle, having a triboelectric charge amount with iron powder of −100 to −300 μC/g, a bulk density of 0.2 to 0.4 g/ml, and a particle diameter of 0.01 to 5 μm as an external additive with respect to 100 parts by weight of the toner.

Patent Literature 2 discloses a toner for electrostatic latent image development using three kinds of external additives including (a) monodisperse spherical silica having a true specific gravity of 1.3 to 1.9 and an average primary particle diameter of 80 to 300 nm, (b) an inorganic compound having an average primary particle diameter of 10 nm or more and less than 30 nm, and (c) an inorganic compound having an average primary particle diameter of 30 nm or more and less than 100 nm as external additives, wherein the added amounts of the external additives (a), (b) and (c) are respectively 0.5 to 5 parts by mass, 0.3 to 3 parts by mass and 0.5 to 5 parts by mass, with respect to 100 parts by mass of a colored particle.

Patent Literature 3 discloses a positively-charged toner composition comprising a resin particle, at least one kind of colorant, and fumed silica in which charge is adjusted by about 0.05 weight % to about 5.0 weight % of cyclic silazane as an external additive.

Patent Literature 4 discloses an electrostatic image developer obtained by using 0.01 to 20 parts by weight of a non-crystalline spherical silica particle having a particle size distribution of 5 to 1,000 nm as an external additive with respect to 100 parts by weight of a toner.

Patent Literature 5 discloses a non-magnetic one-component spherical toner having negatively charging ability obtained by using a hydrophobic inorganic particle having an average particle diameter of 7 to 50 nm and a hydrophobic monodisperse spherical silica particle having an average particle diameter of 70 to 130 nm together as external additives, wherein the contents of the hydrophobic inorganic particle and hydrophobic monodisperse spherical silica particle are respectively in the range from 0.1 to 5 parts by mass and 0.05 to 2 parts by mass with respect to 100 parts by mass of a toner base particle.

However, it is attempted in the toners obtained by using the external additives disclosed in Patent Literatures 1 to 5 to increase the function of the external additive, but the toners do not have sufficiently high performance capable of corresponding to toner replenishment-type image forming devices also, which is required in recent years.

Patent Literature 1: Japanese Patent Application Laid-open (JP-A) No. 2005-15251

Patent Literature 2: JP-A No. 2005-3726

Patent Literature 3: JP-A No. H10-330115

Patent Literature 4: JP-A No. 2000-258947

Patent Literature 5: JP-A No. 2006-58359

### SUMMARY OF INVENTION

### Technical Problem

An object of the present invention is to provide a positively-chargeable toner for developing electrostatic images applicable to a toner replenishment-type image forming device; excellent in reproductivity of thin lines even if continuous printing of a large number of prints is performed as less fog is produced upon replenishment of toner and a stable charging ability and flowability are imparted to toner particles over time; and excellent in printing durability under the high temperature and humidity environment as deterioration of image quality due to fog or the like is hardly caused.

### Solution to Problem

As a result of diligent researches made to attain the above object, the inventor of the present invention found out that a positively-chargeable toner for developing electrostatic images applicable to a toner replenishment-type image forming device, excellent in reproductivity of thin lines, and excellent in printing durability under the high temperature and humidity environment can be obtained by using a combination of a spherical colloidal silica particle and a fumed silica particle having specific characteristics by specific amounts as external additives which are attached by addition on colored resin particles. Based on the above knowledge, the inventor has reached the present invention.

That is, the positively-chargeable toner for developing electrostatic images of the present invention is a positively-chargeable toner for developing electrostatic images comprising a colored resin particle containing a binder resin and a colorant, and external additives,

wherein a spherical colloidal silica particle having a number average primary particle diameter of 30 to 80 nm and a triboelectric charge amount of −50 to +300 μC/g, and a fumed silica particle having a number average primary particle diameter of 5 to 25 nm are contained as the external additives, and

wherein a content of the spherical colloidal silica particle is in the range from 0.3 to 2 parts by weight and a content of the fumed silica particle is in the range from 0.1 to 1 parts by weight with respect to 100 parts by weight of the colored resin particle.

### ADVANTAGEOUS EFFECTS OF INVENTION

According to the positively-chargeable toner for developing electrostatic images of the present invention, the positively-chargeable toner for developing electrostatic images applicable to a toner replenishment-type image forming device; excellent in reproductivity of thin lines even if continuous printing of a large number of prints is performed as less fog is produced upon replenishment of toner and a stable charging ability and flowability are imparted to toner particles over time; and excellent in printing durability under the high temperature and humidity environment as deterioration of image quality due to fog or the like is hardly caused, can be provided.

### DESCRIPTION OF EMBODIMENTS

The positively-chargeable toner for developing electrostatic images of the present invention is a positively-chargeable toner for developing electrostatic images comprising a colored resin particle containing a binder resin and a colorant, and external additives,

wherein a spherical colloidal silica particle having a number average primary particle diameter of 30 to 80 nm and a triboelectric charge amount of −50 to +300 μC/g, and a fumed silica particle having a number average primary particle diameter of 5 to 25 nm are contained as the external additives, and

wherein a content of the spherical colloidal silica particle is in the range from 0.3 to 2 parts by weight and a content of the fumed silica particle is in the range from 0.1 to 1 part by weight with respect to 100 parts by weight of the colored resin particle.

Hereinafter, the positively-chargeable toner for developing electrostatic images (hereinafter, it may be simply referred to as “positively-chargeable toner” or “toner”) of the present invention will be explained.

The toner of the present invention can be obtained by adding a colored resin particle containing a binder resin and a colorant, and specific amounts of spherical colloidal silica and fumed silica having specific characteristics as external additives.

Specific examples of the binder resin include resins such as polystyrene, styrene-butyl acrylate copolymers, polyester resins and epoxy resins, which have been conventionally and widely used in toners.

Generally, methods of producing the colored resin particle are broadly classified into dry methods such as a pulverization method and wet methods such as an emulsion polymerization agglomeration method, a dispersion polymerization method, a suspension polymerization method and a solution suspension method. The wet methods are preferable since toners having excellent printing characteristics such as the reproductivity of thin lines can be easily obtained. Among the wet methods, polymerization methods such as the emulsion polymerization agglomeration method, the dispersion polymerization method, and the suspension polymerization method are preferable since toners which have relatively small particle size distribution in micron order can be easily obtained. Among the polymerization methods, the suspension polymerization method is more preferable.

In the emulsion polymerization agglomeration method, colored resin particles are produced by polymerizing emulsified polymerizable monomers to obtain resin microparticles, and aggregating the resultant resin microparticles with a colorant etc. The solution suspension method is a method of producing colored resin particles by forming droplets of a solution, in which toner components such as a binder resin and a colorant are dissolved or dispersed in an organic solvent, in an aqueous medium, and removing the organic solvent. Both methods can be performed by known methods.

The colored resin particle of the present invention can be produced by employing the wet method or the dry method.

In the case of employing “(A) Suspension polymerization method” preferable among the wet methods or “(B) Pulverization method” typical among the dry methods, the following processes are performed.

### (A) Suspension Polymerization Method

### (1) Preparation Process of Polymerizable Monomer Composition

Firstly, a polymerizable monomer, a colorant, a charge control agent and other additives such as a release agent if required, are mixed and dissolved. Thereby, a polymerizable monomer composition is prepared. Mixing upon preparing the polymerizable monomer composition is performed by means of a media type dispersing machine.

In the present invention, the polymerizable monomer means a monomer having a polymerizable functional group and the polymerizable monomer is polymerized to be a binder resin. As a main component of the polymerizable monomer, a monovinyl monomer is preferably used. Examples of the monovinyl monomer include styrene; styrene derivatives such as vinyl toluene and α-methylstyrene; acrylic acid and methacrylic acid; acrylic acid esters such as methyl acrylate, ethyl acrylate, propyl acrylate, butyl acrylate, 2-ethylhexyl acrylate and dimethylaminoethyl acrylate; methacrylic acid esters such as methyl methacrylate, ethyl methacrylate, propyl methacrylate, butyl methacrylate, 2-ethylhexyl methacrylate and dimethylaminoethyl methacrylate; amide compounds such as acrylamide and methacrylamide; and olefins such as ethylene, propylene and butylene. The monovinyl monomer may be used alone or in combination of two or more kinds.

Among the above monovinyl monomers, styrene, styrene derivatives, acrylic acid esters and methacrylic acid esters are suitably used.

In order to improve the shelf stability of the toner (blocking resistance), as a part of the polymerizable monomer, any crosslinkable polymerizable monomer may be preferably used together with the monovinyl monomer. The crosslinkable polymerizable monomer means a monomer having two or more polymerizable functional groups. Examples of the crosslinkable polymerizable monomer include aromatic divinyl compounds such as divinyl benzene, divinyl naphthalene and derivatives thereof; ethylenic unsaturated carboxylic acid esters such as ethylene glycol dimethacrylate and diethylene glycol dimethacrylate; divinyl compounds such as N,N-divinylaniline and divinyl ether; and compounds having three or more vinyl groups such as trimethylolpropane trimethacrylate and dimethylolpropane tetraacrylate. The crosslinkable polymerizable monomer may be used alone or in combination of two or more kinds.

In the present invention, it is desirable that the amount of the crosslinkable polymerizable monomer is generally from 0.1 to 5 parts by weight, preferably from 0.3 to 2 parts by weight, with respect to 100 parts by weight of the monovinyl monomer.

Further, as a part of the polymerizable monomer, any macromonomer may be preferably used together with the monovinyl monomer so that the balance of the shelf stability and low-temperature fixability of the toner can be improved. The macromonomer is a reactive oligomer or polymer having a polymerizable carbon-carbon unsaturated bond at the end of a polymer chain and generally having a number average molecular weight (Mn) of 1,000 to 30,000. As the macromonomer, an oligomer or polymer having higher glass transition temperature (Tg) than that of a polymer (binder resin) obtained by polymerization of the polymerizable monomer is preferably used.

In the present invention, it is desirable that the amount of the macromonomer is generally in the range from 0.01 to 10 parts by weight, preferably from 0.03 to 5 parts by weight, more preferably from 0.1 to 2 parts by weight, with respect to 100 parts by weight of the monovinyl monomer.

The colorant is used in the present invention. To produce a colored toner, in which four types of toners including a black toner, a cyan toner, a yellow toner and a magenta toner are generally used, a black colorant, a cyan colorant, a yellow colorant and a magenta colorant may be respectively used.

In the present invention, examples of the black colorant to be used include carbon black, titanium black, magnetic powder such as zinc-ferric oxide and nickel-ferric oxide.

Examples of the cyan colorant include compounds such as copper phthalocyanine pigments, derivatives thereof and anthraquinone pigments. The specific examples include C. I. Pigment Blue 2, 3, 6, 15, 15:1, 15:2, 15:3, 15:4, 16, 17:1 and 60.

Examples of the yellow colorant to be used include compounds including azo pigments such as monoazo pigments and disazo pigments, and condensed polycyclic pigments. The specific examples include I. Pigment Yellow 3, 12, 13, 14, 15, 17, 62, 65, 73, 74, 83, 93, 97, 120, 138, 155, 180, 181, 185 and 186.

Examples of the magenta colorant to be used include compounds including azo pigments such as monoazo pigments and disazo pigments, and condensed polycyclic pigments. The specific examples include C. I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209 and 251, and C. I. Pigment Violet 19.

In the present invention, the colorant may be used alone or in combination of two or more kinds. The amount of the colorant to be used is preferably in the range from 1 to 10 parts by weight with respect to 100 parts by weight of the monovinyl monomer.

As other additives, the release agent is preferably used to improve peelability from a fixing roller.

The release agent is not particularly limited as long as it is generally used as a release agent for the toner. The examples include polyolefin waxes such as low-molecular-weight polyethylene, low-molecular-weight polypropylene and low-molecular-weight polybutylene; natural waxes such as candelilla, carnauba waxes, rice waxes, haze waxes and jojoba; petroleum waxes such as paraffin, microcrystalline and petrolactam; mineral waxes such as montan, ceresin and ozokerite; synthesized waxes such as Fischer-Tropsch waxes; and esterified compounds of polyalcohol including pentaerythritol ester such as pentaerythritol tetramyristate, pentaerythritol tetrapalmitate, pentaerythritol tetrastearate and pentaerythritol tetralaurate, and dipentaerythritol ester such as dipentaerythritol hexamyristate, dipentaerythritol hexapalmitate and dipentaerythritol hexylaurate. The release agents may be used alone or in combination of two or more kinds.

In the present invention, it is desirable that the amount of the release agent is generally in the range from 0.1 to 30 parts by weight, preferably from 1 to 20 parts by weight, with respect to 100 parts by weight of the monovinyl monomer.

As one of other additives, various kinds of charge control agents having positively charging ability may be used to improve the charging ability of the toner.

The charge control agent is not particularly limited as long as it is generally used as a charge control agent having positively charging ability for the toner. In the present invention, among the charge control agents having positively charging ability, a charge control resin having positively charging ability is preferably used since the charge control resin is highly compatible with the polymerizable monomer and can impart a stable charging ability (charge stability) to the toner particles.

As the charge control resins having positively charging ability, various types of commercial products can be used. Examples of commercial products manufactured by Fujikura Kasei Co., Ltd. include FCA-161P (product name; a styrene/acrylate resin), FCA-207P (product name; a styrene/acrylate resin), and FCA-201-PS (product name; a styrene/acrylate resin).

In the present invention, it is desirable that the amount of the charge control agent to be used is generally in the range from 0.01 to 10 parts by weight, preferably from 0.03 to 8 parts by weight, with respect to 100 parts by weight of the monovinyl monomer.

As one of other additives, a molecular weight modifier is preferably used.

The molecular weight modifier is not particularly limited as long as it is generally used as a molecular weight modifier for the toner. Examples of the molecular weight modifier include mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N,N′-diphenyl thiuram disulfide and N,N′-dioctadecyl-N,N′-diisopropyl thiuram disulfide. The above molecular weight modifier may be used alone or in combination of two or more kinds.

In the present invention, it is desirable that the amount of the molecular weight modifier is generally in the range from 0.01 to 10 parts by weight, preferably from 0.1 to 5 parts by weight, with respect to 100 parts by weight of the monovinyl monomer.

### (2) Suspension Process of Obtaining Suspension (Droplets Forming Process)

The polymerizable monomer composition obtained through “(1) Preparation process of polymerizable monomer composition” is suspended in an aqueous dispersion medium, thus, a suspension (polymerizable monomer composition dispersion liquid) is obtained. Herein, “suspension” means that droplets of the polymerizable monomer composition are formed in the aqueous dispersion medium. Dispersion treatment for forming the droplets may be performed by means of a device capable of strong stirring such as an in-line type emulsifying and dispersing machine (product name: EBARA MILDER; manufactured by Ebara Corporation), and a high-speed emulsification dispersing machine (product name: T. K. HOMOMIXER MARK II; manufactured by PRIMIX Corporation).

In the present invention, a dispersion stabilizer is preferably added in the aqueous dispersion medium upon forming the droplets to improve control of particle diameters and circularity of the colored resin particle.

The aqueous dispersion medium may be water alone or any of water-soluble solvents such as lower alcohols and lower ketones may be used together with water.

Examples of the dispersion stabilizer include sulfates such as barium sulfate and calcium sulfate; carbonates such as barium carbonate, calcium carbonate and magnesium carbonate; phosphates such as calcium phosphate; metallic compounds including metallic oxides such as aluminum oxide and titanium oxide; and metallic hydroxides such as aluminum hydroxide, magnesium hydroxide and ferric hydroxide; water-soluble polymer compounds such as polyvinyl alcohol, methyl cellulose and gelatin; and organic polymer compounds such as anionic surfactants, nonionic surfactants and ampholytic surfactants.

Among the above dispersion stabilizers, a dispersion stabilizer containing colloid of hardly water-soluble metal hydroxide (hardly water-soluble inorganic compound) which is soluble in an acid solution is preferably used. The above dispersion stabilizers may be used alone or in combination of two or more kinds.

The added amount of the dispersion stabilizer is preferably in the range from 0.1 to 20 parts by weight, more preferably from 0.2 to 10 parts by weight, with respect to 100 parts by weight of the polymerizable monomer.

Examples of a polymerization initiator which is used in the polymerization of the polymerizable monomer composition include inorganic persulfates such as potassium persulfate and ammonium persulfate; azo compounds such as 4,4′-azobis(4-cyanovaleric acid), 2,2′-azobis(2-methyl-N-(2-hydroxyethyl)propionamide, 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-hexylperoxy-2-ethylhexanoate, t-butylperoxypyvalate, diisopropylperoxydicarbonate, di-t-butylperoxyisophthalate and t-butylperoxyisobutyrate. Among the above, the organic peroxides are preferably used.

The polymerization initiator may be added after dispersing the polymerizable monomer composition to the aqueous dispersion medium containing the dispersion stabilizer and before forming droplets, or may be directly added to the polymerizable monomer composition.

The added amount of the polymerization initiator is preferably in the range from 0.1 to 20 parts by weight, more preferably from 0.3 to 15 parts by weight, further more preferably from 1.0 to 10 parts by weight, with respect to 100 parts by weight of the monovinyl monomer.

### (3) Polymerization Process

The desirable suspension (the aqueous dispersion medium containing droplets of the polymerizable monomer composition) obtained in “(2)

Suspension process of obtaining a suspension (droplets forming process)” is heated to polymerize. Thereby, an aqueous dispersion liquid of colored resin particles can be obtained.

In the present invention, the polymerization temperature is preferably 50° C. or more, more preferably in the range from 60 to 98° C. The polymerization reaction time is preferably in the range from 1 to 20 hours, more preferably from 2 to 15 hours, in the present invention.

In order to polymerize droplets of the polymerizable monomer composition in a stably dispersed state, the polymerization reaction may proceed while agitating the droplets for dispersion treatment in the polymerization process continuously after “(2) Suspension process of obtaining suspension (droplets forming process)”.

In the present invention, it is preferable to form a so-called core-shell type (or “capsule type”) colored resin particle, which can be obtained by using the colored resin particle obtained by the polymerization process as a core and forming a shell, a material of which is different from that of the core, around the core.

The core-shell type colored resin particles can take a balance of lowering of fixing temperature and prevention of blocking at storage of the toner by covering the core including a substance having a low-softening point with a substance having a high-softening point.

A method for producing the core-shell type colored resin particles mentioned above is not particularly limited, and may be produced by any conventional method. The in situ polymerization method and the phase separation method are preferable from the viewpoint of production efficiency.

A method of producing the core-shell type colored resin particles according to the in situ polymerization method will be hereinafter described.

A polymerizable monomer (a polymerizable monomer for shell) for forming a shell and a polymerization initiator for shell are added to an aqueous dispersion medium to which the colored resin particles are dispersed followed by polymerization, thus the core-shell type colored resin particles can be obtained.

As the polymerizable monomer for shell, the above described polymerizable monomers can be similarly used. Among the above, any of monomers which provide a polymer having Tg of more than 80° C. such as styrene and methyl methacrylate may be preferably used alone or in combination of two or more kinds.

Examples of the polymerization initiator for shell used for polymerization of the polymerizable monomer for shell include polymerization initiators including metal persulfates such as potassium persulfate and ammonium persulfate; and water-soluble azo compounds such as 2,2′-azobis-(2-methyl-N-(2-hydroxyethyl)propionamide) and 2,2′-azobis-(2-methyl-N-(1,1-bis(hydroxymethyl)-2-hydroxy ethyl)propionamide).

The added amount of the polymerization initiator for shell used in the present invention is preferably in the range from 0.1 to 30 parts by weight, more preferably from 1 to 20 parts by weight, with respect to 100 parts by weight of the polymerizable monomer for shell.

The polymerization temperature of the shell is preferably 50° C. or more, more preferably in the range from 60 to 95° C. The polymerization time of the shell is preferably in the range from 1 to 20 hours, more preferably from 2 to 15 hours.

### (4) Processes of Washing, Filtering, Dehydrating and Drying

It is preferable that the aqueous dispersion liquid of the colored resin particles obtained after “(3) Polymerization process” is subjected to a series of operations including washing, filtering, dehydrating, and drying several times as needed according to any conventional method.

Firstly, in order to remove the dispersion stabilizer remained in the aqueous dispersion liquid of the colored resin particles, acid or alkali is added to the aqueous dispersion liquid of the colored resin particles to wash.

If the dispersion stabilizer being used is an acid-soluble inorganic compound, acid is added to the aqueous dispersion liquid of the colored resin particles. On the other hand, if the dispersion stabilizer being used is an alkali-soluble inorganic compound, alkali is added to the aqueous dispersion liquid of the colored resin particles.

If the acid-soluble inorganic compound is used as the dispersion stabilizer, it is preferable to control pH of the aqueous dispersion liquid of the colored resin particles to 6.5 or less by adding acid. It is more preferable to control pH to 6 or less. Examples of the acid to be added include inorganic acids such as sulfuric acid, hydrochloric acid and nitric acid, and organic acids such as formic acid and acetic acid. Particularly, sulfuric acid is suitable for high removal efficiency of the dispersion stabilizer and small impact on production facilities.

### (B) Pulverization Method

In the case of producing the colored resin particles by employing the pulverization method, the following processes are performed.

Firstly, a binder resin, a colorant, a charge control agent, and if required, other additives to be added such as a release agent are mixed by means of a mixer such as a ball mill, a V type mixer, Henschel Mixer (product name), a high-speed dissolver, an internal mixer or a whole burg internal mixer. Next, the mixture obtained by the above is kneaded while heating by means of a press kneader, a twin screw kneading machine or a roller. The obtained kneaded product is crushed by means of a pulverizer such as a hammer mill, a cutter mill or a roller mill, followed by finely pulverizing by means of a pulverizer such as a jet mill or a high-speed rotary pulverizer, and classifying into desired particle diameters by means of a classifier such as a wind classifier or an airflow classifier. Thus, colored resin particles produced by the pulverization method can be obtained.

The binder resin, the colorant, the charge control agent, and if required, other additives to be added such as the release agent used in “(A) Suspension polymerization method” can be used in the pulverization method. Similarly as the colored resin particles obtained by “(A) Suspension polymerization method”, the colored resin particles obtained by the pulverization method can also be in a form of the core-shell type colored resin particles produced by a method such as the in situ polymerization method.

### (5) Colored Resin Particle

The colored resin particles can be obtained by “(A) Suspension polymerization method” or “(B) Pulverization method”.

The colored resin particles constituting the toner will be hereinafter described. Hereinafter, the colored resin particles include both core-shell type colored resin particles and colored resin particles which are not core-shell type.

The volume average particle diameter “Dv” of the colored resin particles constituting the toner is preferably in the range from 4 to 12 μm, more preferably from 5 to 11 μm, further more preferably from 6 to 10 μm, from the viewpoint of image reproducibility.

If “Dv” of the colored resin particles is less than the above range, the flowability of the toner lowers, deterioration of image quality due to fog or the like tends to occur, and adverse effect on printing performance may be caused. On the other hand, if “Dv” of the colored resin particles exceeds the above range, the resolution of images to be obtained tends to decline, and adverse effect on printing performance may be caused.

As for the colored resin particles, a particle size distribution (Dv/Dn), which is the ratio of a volume average particle diameter “Dv” and a number average particle size “Dn”, is preferably in the range from 1.0 to 1.3, more preferably from 1.0 to 1.25, further more preferably from 1 to 1.2, from the viewpoint of image reproducibility.

If the particle size distribution (Dv/Dn) of the colored resin particles exceeds the above range, the flowability of the toner lowers, deterioration of image quality due to fog or the like tends to occur, and adverse effect on printing performance may be caused.

The value of “Dv” and “Dn” of the colored resin particles may be measured by means of a particle diameter measuring device.

In addition, the average circularity of the colored resin particles is preferably 0.975 or more, more preferably 0.978 or more, further more preferably 0.982 or more, from the viewpoint of image reproducibility.

If the average circularity of the colored resin particles is less than the above range, the reproductivity of thin lines tends to decline and adverse effect on printing performance may be caused.

In the present invention, circularity is a value obtained by dividing a perimeter of a circle having an area same as a projected area of a particle by a perimeter of a particle image. Also, in the present invention, an average circularity is used as a simple method of quantitatively presenting shapes of particles and is an indicator showing the level of convexo-concave shapes of the colored resin particle. The average circularity is “1” when the colored resin particle is an absolute sphere, and becomes smaller as the shape of the surface of the colored resin particle becomes more complex. In order to obtain the average circularity (Ca), firstly, the circularity (Ci) of each of measured “n” particles of 0.6 μm or more by the diameter of an equivalent circle is calculated by the following Calculation formula 1. Next, the average circularity (Ca) is obtained by the following Calculation formula 2.

Circularity (Ci)=a perimeter of a circle having an area same as a projected area of a particle/a perimeter of a particle image Calculation formula 1

Calculation formula 2:

$$Ca = \frac{{\sum }_{i = 1}^{n} ( Ci \times fi )}{{\sum }_{i = 1}^{n} ( fi )}$$

In Calculation formula 2, “fi” is the frequency of particles of circularity (Ci).

The above circularity may be measured by means of any of flow particle image analyzers FPIA-2000, FPIA-2100 and FPIA-3000 (product name; manufactured by Sysmex Co.).

### (6) External Addition Process

The colored resin particles obtained in “(A) Suspension polymerization method” or “(B) Pulverization method” are mixed and agitated together with two kinds of silica particles (“spherical colloidal silica particles” and “fumed silica particles”) specified in the present invention. Thereby, two kinds of silica particles can be uniformly and suitably attached by addition (externally added) on the surface of the colored resin particles.

A method for attaching or externally adding two kinds of silica particles specified in the present invention on the surface of the colored resin particles is not particularly limited and can be performed by means of a device capable of mixing and agitating.

Examples of typical devices capable of mixing and agitating include high speed agitators such as Henschel Mixer (product name; manufactured by NIPPON COKE & ENGINEERING CO., LTD.), SUPER MIXER (product name; manufactured by KAWATA MFG Co., Ltd.), Q MIXER (product name; manufactured by NIPPON COKE & ENGINEERING CO., LTD.), Mechanofusion system (product name; manufactured by Hosokawa Micron Corporation), MECHANOMILL (product name; manufactured by OKADA SEIKO CO., LTD.) and Nobilta (product name; manufactured by Hosokawa Micron Corporation).

In the present invention, two kinds of silica particles having different ranges of particle diameter including “spherical colloidal silica particle” and “fumed silica particle” having specific characteristics as external additives are used together by specific amounts.

By using the “spherical colloidal silica particle” having specific characteristics as an external additive, the effect of preventing burial of microparticles of the external additive on the surface of toner particles (spacer effect) can be exhibited. In addition, by using the “spherical colloidal silica particle” together with the “fumed silica particle” having specific characteristics, the effect of imparting flowability to the toner particles can be exhibited.

Hereinafter, the characteristics of the “spherical colloidal silica particle” and the “fumed silica particle” specified in the present invention will be described.

The number average primary particle diameter of the spherical colloidal silica particles used in the present invention is in the range from 30 to 80 nm, preferably from 40 to 80 nm, more preferably from 45 to 75 nm.

If the number average primary particle diameter of the spherical colloidal silica particles is less than the above range, the spacer effect decreases so that the silica particles are easily buried on the surface of toner particles, and suitable flowability cannot be imparted to the toner particles over time, thus, adverse effect on printing performance may be caused. On the other hand, if the number average primary particle diameter of the spherical colloidal silica particles exceeds the above range, the silica particles are easily released from the surface of the toner particles so that the functions as the external additive may decrease, thus adverse effect on printing performance may be caused.

The triboelectric charge amount of the spherical colloidal silica particle used in the present invention is in the range from −50 to +300 μC/g, preferably from +5 to +250 μC/g, more preferably from +10 to +220 μC/g.

The term “triboelectric charge amount” as used herein means a triboelectric charge amount (frictional charge quantity per unit weight) with a ferrite being a standard carrier, and is a value which can be measured by a blow off method by means of a blow-off method powder electrification measurement system (product name: TB-200; manufactured by Toshiba Chemical Corporation).

If the triboelectric charge amount of the spherical colloidal silica particle is less than the above range, aggregation of particles tends to occur and suitable flowability cannot be imparted to toner particles over time, thus adverse effect on printing performance may be caused. On the other hand, if the triboelectric charge amount of the spherical colloidal silica particle exceeds the above range, the toner particles are excessively charged so that the transfer is not suitably performed, and the residual toner after transfer increases on the photosensitive member, thus adverse effect on printing performance may be caused.

The loose apparent bulk density of the spherical colloidal silica particle used in the present invention is preferably in the range from 0.15 to 0.35 g/ml, more preferably from 0.18 to 0.32 g/ml, further more preferably from 0.2 to 0.3 g/ml.

The term “loose apparent bulk density” as used herein means an apparent bulk density when a powder sample is horizontally packed (loose packing) in a container capable of measuring volume through a sieve not to cause powder compacting. The loose apparent bulk density can be measured by means of a powder tester (product name: model PT-R) manufactured by Hosokawa Micron Corporation.

If the loose apparent bulk density of the spherical colloidal silica particle is less than the above range, aggregation of particles tends to occur and suitable flowability cannot be imparted to toner particles over time, thus adverse effect on printing performance may be caused. On the other hand, if the loose apparent bulk density of the spherical colloidal silica particle exceeds the above range, the silica particles are buried on the surface of colored resin particles and flowability cannot be suitably imparted to the toner particles, thus, adverse effect on printing performance may be caused.

The content of the spherical colloidal silica particle used in the present invention is in the range from 0.3 to 2 parts by weight, preferably from 0.4 to 1.8 parts by weight, more preferably from 0.5 to 1.5 parts by weight, with respect to 100 parts by weight of the colored resin particle.

If the content of the spherical colloidal silica particle is less than the above range, the functions as the external additive cannot be sufficiently exhibited, thus adverse effect on printing performance may be caused. On the other hand, if the content of the spherical colloidal silica particle exceeds the above range, the silica particles are easily released from the surface of the toner particles and the functions as the external additive decrease, thus adverse effect on printing performance may be caused.

As the spherical colloidal silica particle used in the present invention, commercially available spherical colloidal silica particles may be used. Also, the spherical colloidal silica particle may be synthesized according to prior arts such as JP-A No. 2006-151764 etc.

The number average primary particle diameter of the fumed silica particle used in the present invention is in the range from 5 to 25 nm, preferably from 6 to 20 nm, more preferably from 7 to 15 nm.

If the number average primary particle diameter of the fumed silica particles is less than the above range, the silica particles are easily buried on the surface of colored resin particles and flowability cannot be sufficiently imparted to the toner particles, thus adverse effect on printing performance may be caused. On the other hand, if the number average primary particle diameter of the fumed silica particles exceeds the above range, the ratio of the silica particles (coverage) to the surface of the toner particles declines so that flowability cannot be sufficiently imparted to the toner particles, thus adverse effect on printing performance may be caused.

The loose apparent bulk density of the fumed silica particle used in the present invention is preferably in the range from 0.01 to 0.1 g/ml, more preferably from 0.02 to 0.09 g/ml, further more preferably from 0.03 to 0.085 g/ml.

If the loose apparent bulk density of the fumed silica particle is less than the above range, aggregation of particles tends to occur and stable flowability cannot be imparted to toner particles over time, thus adverse effect on printing performance may be caused. On the other hand, if the loose apparent bulk density of the fumed silica particle exceeds the above range, the silica particles are easily released from the surface of the toner particles and the functions as the external additive decrease, thus adverse effect on printing performance may be caused.

The content of the fumed silica particle used in the present invention is in the range from 0.1 to 1.0 part by weight, preferably from 0.1 to 0.9 parts by weight, more preferably from 0.2 to 0.7 parts by weight, with respect to 100 parts by weight of the colored resin particle.

If the content of the fumed silica particle is less than the above range, the functions as the external additive cannot be sufficiently exhibited, thus adverse effect on printing performance may be caused. On the other hand, if the content of the fumed silica particle exceeds the above range, the silica particles are easily released from the surface of the toner particles and the functions as the external additive decrease, thus adverse effect on printing performance may be caused.

The spherical colloidal silica particle and the fumed silica particle used in the present invention are preferably subjected to surface treatment using cyclic silazane as a hydrophobicity-imparting treatment agent, from the viewpoint that the charge change of toner particles is hardly caused and positively-chargeable toners can be obtained.

The cyclic silazane used as the hydrophobicity-imparting treatment agent in the present invention is not particularly limited as long as it is well-known cyclic silazane. The examples of the cyclic silazane include one disclosed in JP-A No. H10-330115 (Patent Literature 3). Among the above, the cyclic silazane represented by the following formula 1 is preferably used.

Formula 1:

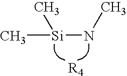

In the above formula 1, it is preferable that silazane containing R₄ represented by the following formula 2 is five membered or six membered cyclic silazane:

[(CH₂)a(CHX)b(CYZ)c] Formula 2

In the above formula 2, each of X, Y and Z is independently selected from the group consisting of hydrogen, halogen, alkyl, alkoxy, aryl and aryloxy, and each of a, b and c is an integer of 0 to 6 which meets the condition that a+b+c is equivalent to an integer of 3 or 4.

Among the cyclic silazanes represented by the above formulae 1 and 2, the cyclic silazane represented by the following formula 3, in which X is a methyl group, Y and Z are respectively hydrogen, and a, b and c are respectively 1, is particularly preferably used.

Formula 3:

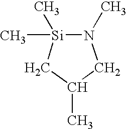

The examples of the method of the surface treatment using the hydrophobicity-imparting treatment agent of the present invention include a method of surface treatment in which a hydrophobicity-imparting treatment agent is added dropwise or sprayed while agitating an external additive, and a method of surface treatment in which an external additive is added to an organic solvent in which a hydrophobicity-imparting treatment agent is dissolved while agitating the organic solvent. In the former method, the hydrophobicity-imparting treatment agent may be diluted with the organic solvent or the like.

In the present invention, the added amount of the cyclic silazane used as the hydrophobicity-imparting treatment agent is in the range from 1 to 30 parts by weight, preferably from 2 to 20 parts by weight, more preferably from 3 to 15 parts by weight, with respect to 100 parts by weight of the “spherical colloidal silica particle” or the “fumed silica particle” specified in the present invention.

If the added amount of the cyclic silazane is less than the above range, the charge amount of toners decreases and fog may be caused under the high temperature and humidity environment. On the other hand, if the added amount of the cyclic silazane exceeds the above range, moisture in air is absorbed and fog may be caused.

In the present invention, it is preferable to further use “fatty acid metal salt particle” together as external additives besides using two kinds of silica particles as specified above together, from the viewpoint of improving the printing durability of the toner.

The term “fatty acid metal salt particle” as used herein means a salt particle containing “metal” and “higher fatty acid (R—COOH)” having an alkyl group (R—) of 11 to 30 carbons, preferably 12 to 24 carbons.

Examples of “metal” constituting the fatty acid metal salt used in the present invention include Li, Na, K, Rb, Cs, Be, Mg, Ca, Sr, Ba and Zn.

Examples of “higher fatty acid (R—COOH)” constituting the fatty acid metal salt used in the present invention include lauric acid (CH₃(CH₂)₁₀COOH), tridecanoic acid (CH₃(CH₂)₁₁COOH), myristic acid (CH₃(CH₂)₁₂COOH), pentadecanoic acid (CH₃(CH₂)₁₃COOH), palmitic acid (CH₃(CH₂)₁₄COOH), heptadecanoic acid (CH₃(CH₂)₁₅COOH), stearic acid (CH₃(CH₂)₁₆COOH), arachidic acid (CH₃(CH₂)₁₈COOH), behenic acid (CH₃(CH₂)₂₀COOH), and lignoceric acid (CH₃(CH₂)₂₂COOH).

Specific examples of the fatty acid metal salt used in the present invention include metal laurates such as lithium laurate, sodium laurate, potassium laurate, magnesium laurate, calcium laurate and barium laurate; metal myristates such as lithium myristate, sodium myristate, potassium myristate, magnesium myristate, calcium myristate and barium myristate; metal palmitates such as lithium palmitate, sodium palmitate, potassium palmitate, magnesium palmitate, calcium palmitate and barium palmitate; and metal stearates such as lithium stearate, sodium stearate, potassium stearate, magnesium stearate, calcium stearate, barium stearate and zinc stearate.

The number average primary particle diameter of the fatty acid metal salt particle used in the present invention is generally in the range from 0.1 to 5 μm, preferably from 0.2 to 3 μm, more preferably from 0.3 to 2 μm.

If the number average primary particle diameter of the fatty acid metal salt particle is less than the above range, charging ability of toners lowers and fog may be caused. On the other hand, if the number average primary particle diameter of the fatty acid metal salt particle exceeds the above range, white spots may be caused on printing images.

The content of the fatty acid metal salt particle used in the present invention is preferably in the range from 0.01 to 0.5 parts by weight, more preferably from 0.01 to 0.3, further more preferably from 0.02 to 0.2 parts by weight, with respect to 100 parts by weight of the colored resin particle.

If the content of the fatty acid metal salt particle is less than the above range, the effect of improving the printing durability of toners cannot be sufficiently obtained. On the other hand, if the content of the fatty acid metal salt particle exceeds the above range, the flowability of toners lowers and blur may be caused.

### (7) Toner

The toner obtained as a result of the processes (1) to (6) uses the spherical colloidal silica particle and the fumed silica particle having specific characteristics as external additives by specific amounts, thereby, the toner is excellent in reproductivity of thin lines even if continuous printing of a large number of prints is performed as less fog is produced upon replenishment of toner and a stable charging ability and flowability are imparted to toner particles over time and excellent in printing durability in an atmosphere of high temperature and high humidity as deterioration of image quality due to fog or the like is hardly caused.

In the toner obtained in the present invention, if the fatty acid metal salt particle is used as the external additive, besides using a combination of the specified “spherical colloidal silica particle” and the “fumed silica particle” as the external additives, the fatty acid metal salt particle supplementarily functions to optimize the charging ability of the toner, thus, the toner having more excellent printing durability can be obtained.

The toner obtained as a result of the processes (1) to (6) is suitably applied to an image forming method having processes such as a charge process, an exposure process, a development process, a transfer process and a fixing process.

The toner obtained in the present invention can significantly reduce the amount of the toner remained on the photosensitive member after transfer (residual toner after transfer) in the transfer process of the image forming method, therefore, the toner can be also suitably applied to a cleanerless image forming method which does not use a cleaning means such as a cleaning blade.

### EXAMPLES

Hereinafter, the present invention will be explained further in detail with reference to examples and comparative examples. However, the scope of the present invention may not be limited to the following examples. Herein, “part(s)” and “%” are based on weight if not particularly mentioned.

Evaluation methods used in the examples and the comparative examples are as follows.

### (Evaluation Method)

### (1) External Additive

### (1-1) Number Average Primary Particle Diameter

The number average primary particle diameter of an external additive was determined by: taking an electron micrograph of particles of the external additive; and calculating the arithmetic mean value of diameters of the equivalent circles corresponding to projected areas of the particles in the electron micrograph under the condition that the area ratio of particles to a frame area is up to 2% and the total number of analyzed particles is 100, by means of an image analyzing system (product name: LUZEX IID; manufactured by NIRECO CORPORATION).

### (1-2) Loose Apparent Bulk Density

The loose apparent bulk density was measured by means of a powder tester (product name: model PT-R, manufactured by Hosokawa Micron Corporation) as follows.

A powder sample (an external additive) was horizontally packed (loose packing) in a cylindrical container (diameter: 5.4 cm; height: 5.2 cm; volume: 100 ml) being a measuring container from 22 cm above the container through a sieve (width of opening: 1.7 mm (10 meshes)) not to cause powder compacting. Next, the volume (ml) of the packed powder sample (the external additive) was precisely measured, and the weight (g) of the container in which the powder sample (the external additive) was packed was measured. Then, the loose apparent bulk density (ρ₀) was calculated by the following formula 3.

The weight of an empty cylindrical container being the measuring container was preliminarily measured.

Calculation formula 3:

$${ρ}_{0} = \frac{\begin{matrix}( weight ( g ) of container filled with sample ) - \\ ( weight ( g ) of empty container )\end{matrix}}{Volume ( ml ) of sample}$$

### (1-3) Triboelectric Charge Amount

The concentration of a test sample (spherical colloidal silica particle) was adjusted to be 0.05 weight % using a ferrite (product name: EF-80B2; manufactured by Powdertech Co., Ltd.) being a standard carrier, and the test sample was mixed and agitated for 30 minutes by means of a ball mill agitator (product name: table ball mill rotary rack; manufactured by IRIE SHOKAI Co., Ltd.) to cause frictional charge. Thus, a test sample mixture was produced.

0.2 g of the test sample mixture was precisely weighted and blowed off for 30 seconds at 0.1 MPa of nitrogen gas pressure by means of a blow-off method powder electrification measurement system (product name: TB-200; manufactured by Toshiba Chemical Corporation), and then, the charge amount (μC) of the test sample mixture was measured.

The triboelectric charge amount of the test sample (spherical colloidal silica particle) was calculated by: dividing the measured value of the charge amount of the test sample mixture by the measured weight of test sample mixture; further dividing the resultant value by the concentration of the test sample; and calculating the resultant value to the triboelectric charge amount per unit weight by the following formula 4.

Calculation formula 4:

$$Frictional charge amount ( µ C \text{/} g ) = \frac{\begin{matrix}charge amount ( µ C ) of \\ test sample mixture\end{matrix} }{\begin{matrix}\begin{matrix}weight ( g ) of test \\ sample mixture \times \\ concentration ( weight \% )\end{matrix} \\ of test sample\end{matrix} }$$

### (2) Colored Resin Particles

### (2-1) Volume Average Particle Dimameter “Dv” and Particle Size Distribution “Dv/Dn”

About 0.1 g of a test sample (colored resin particle) was weighed and charged into a beaker. Then, 0.1 ml of an aqueous solution of alkyl benzene sulfonate (product name: DRIWEL; manufactured by FUJIFILM Corporation) was added therein as a dispersant. Further, from 10 to 30 ml of ISOTON II was added to the beaker. The mixture was dispersed by means of an ultrasonic disperser at 20 watts for 3 minutes. Then, the volume average particle diameter “Dv” and the number average particle diameter “Dn” of the colored resin particles were measured by means of a particle diameter measuring device (product name: MULTISIZER; manufactured by Beckman Coulter, Inc.) under the condition of an aperture diameter of 100 μm, using ISOTON II as a medium, and a number of the measured particles of 100,000. Therefrom, the particle size distribution (Dv/Dn) was calculated.

### (2-1) Average Circularity

Into a container pre-filled with ion-exchanged water of 10 ml, 0.02 g of a surfactant (alkyl benzene sulfonate) as a dispersant and 0.02 g of a test sample (colored resin particle) were charged. Then, dispersion treatment was performed by means of an ultrasonic disperser at 60 W (watts) for 3 minutes. The concentration of colored resin particles was adjusted to be 3,000 to 10,000 particles/μL during measurement, and 1,000 to 10,000 colored resin particles having a diameter of 0.4 μm or more by a diameter of the equivalent circle were subjected to measurement by means of a flow particle image analyzer (product name: FPIA-2100; manufactured by Sysmex Co.). The average circularity was calculated from measured values thus obtained.

Circularity can be calculated by the following Calculation formula 1, and the average circularity is an average of the calculated circularities:

Circularity=a perimeter of a circle having an area same as a projected area of a particle/a perimeter of a projected image of a particle Calculation formula 1

### (3) Printing Test

### (3-1) Blade Fixing

A commercially available printer of the non-magnetic one-component developing method (printing speed: 20 prints in A4 size per minute) was used for a blade fixing test. A toner was charged in a toner cartridge of a development device and printing paper was set in the printer.

After the printer was left under the normal temperature and humidity environment (N/N) having a temperature of 23° C. and a humidity of 50% for 24 hours, printing test with 1% image density was performed under the N/N environment. A halftone patterned image with 50% image density was printed every 500 prints and generation of vertical stripes by the blade fixing was confirmed. The number of sheets when the vertical stripes was firstly confirmed on the halftone patterned image (the number of sheets having filming generation) was counted and the printing test was performed up to 10,000 sheets.

The printing test was not stopped when vertical stripes by the blade fixing was confirmed on the halftone patterned image, but was stopped at the time of generation of fog. In Table 1, “S” means that both vertical stripes and fog did not generate at the time of 10,000 prints, “M” means that vertical stripes generated at the time of less than 10,000 prints and “L” means that vertical stripes generated at the time of less than 5,000 prints.

### (3-2) Reproductivity of Thin Lines (Under N/N Environment)

A commercially available printer of the non-magnetic one-component developing method (printing speed: 20 prints in A4 size per minute) was used for a test of reproductivity of thin lines. A toner was charged in a toner cartridge of a development device and printing paper was set in the printer.

After the printer was left under the normal temperature and humidity environment (N/N) having a temperature of 23° C. and a humidity of 50% for 24 hours, line images with 2×2 dotline (width: about 85 μm) were continuously formed under the N/N environment and continuous printing was performed up to 10,000 sheets.

The concentration distribution data of the line images was collected every 500 prints by means of a printing evaluation system (product name: RT2000; manufactured by YA-MA, Inc.).

When defining the full width of an line image having a concentration being half value of the maximum concentration in the collected concentration distribution data of line images as a line width, and using a line width formed on the printing paper which was firstly collected as a reference, the number of prints of continuous printing, which can maintain the difference between the line widths to be 10 μm or less, was counted.

In Table 1, “10,000<” means that the difference between the line widths can be maintained to 10 μm or less at the time of 10,000 prints.

### (3-3) Printing Durability (Under N/N Environment and H/H Environment)

A commercially available printer of the non-magnetic one-component developing method (printing speed: 20 prints in A4 size per minute) was used for a test of printing durability. A toner was charged in a toner cartridge of a development device and printing paper was set in the printer.

After the printer was left under the normal temperature and humidity environment (N/N) having a temperature of 23° C. and a humidity of 50% for 24 hours, continuous printing with 5% image density was performed up to 15,000 prints under the N/N environment.

A solid patterned image with 100% image density was printed every 500 prints and the image density of the solid patterned image was measured by means of a reflection image densitometer (product name: RD918; manufactured by Gretag Macbeth Co.). Further, after a solid patterned image with 0% image density was printed with the printer followed by stopping the printer in mid-course of solid pattern printing, the toner remained in a non-image area on the photosensitive member after development was attached to an adhesive tape (product name: SCOTCH MENDING TAPE 810-3-18; manufactured by Sumitomo 3M Limited) and peeled. The tape was attached to a new printing paper, and the whiteness (B) of the printing paper with the tape was measured by means of a whiteness colorimeter (product name: ND-1; manufactured by NIPPON DENSHOKU INDUSTRIES CO., LTD.). Similarly, an unused tape was attached to a printing paper to measure the whiteness (A). The difference of these whiteness (B-A) was referred to as a fog value (%). As the fog value decreases, it means that less fog is produced and image quality is excellent.

The number of prints by continuous printing, which can maintain the image quality having an image density of 1.3% or more and a fog value of 3% or less, was counted.

The similar test of printing durability was performed under the high temperature and humidity environment (H/H) having a temperature of 35° C. and a humidity of 80%.

In Table 1, “15,000<” means that the image quality having an image density of 1.3% or more and a fog value of 3 or less can be maintained at the time of 15,000 prints.

(3-4) Fog Soon after Replenishment of Toner

After the above test in (3-3) Printing durability (under N/N environment), 30 g of the remaining toners in the development device was left and 100 g of new toners were replenished therein. After a solid patterned image with 0% image density was printed followed by stopping the printer in mid-course of solid pattern printing, the toner remained in a non-image area on the photosensitive member after development was attached to an adhesive tape (product name: SCOTCH MENDING TAPE 810-3-18; manufactured by Sumitomo 3M Limited) and peeled. The tape was attached to a new printing paper, and the whiteness (B) of the printing paper with the tape was measured by means of a whiteness colorimeter (product name: NDW-1D; manufactured by NIPPON DENSHOKU INDUSTRIES CO LTD.). Similarly, an unused tape was attached to a printing paper to measure the whiteness (A). The difference of these whiteness (B-A) was referred to as a fog value (%). As the fog value decreases, it means that less fog is produced and image quality is excellent.

At the time of printing soon after replenishment of toner, the fog value was 3% or more. However, the fog value gradually decreased while printing being continued. The number of prints at the time that the fog value was 3% or less was counted and this value was referred to as the number of prints having fog disappearance soon after replenishment of the toner.

### Method of Producing Spherical Colloidal Silica Particles

### Production Example 1

### (I) Synthesis of Hydrophilic Spherical Colloidal Silica Particle 1

623.7 g of methanol, 41.4 g of water and 49.8 g of 28% ammonia water were charged in a 3 L glass reactor provided with an agitator, a dropping funnel and a thermometer, and mixed. The temperature of the mixed solution was adjusted to be 35° C. and a mixture of 1,205.0 g of tetramethoxysilane and 100.6 g of tetrabutoxysilane, and 418.1 g of 5.4% ammonia water were gradually added to the mixed solution at the same time while agitating. The mixture of tetramethoxysilane and tetrabutoxysilane was added dropwise for 6 hours and the 5.4% ammonia water was added dropwise for 5 hours, respectively.

Even after finishing the dropping, the hydrolysis was performed by further continuing 0.5-hour agitation. Thus, a suspension of hydrophilic spherical silica particles was obtained.

Next, an ester adapter and a condenser were mounted on the 3 L glass reactor, and the temperature of the obtained suspension was raised up to 60 to 70° C. to distill (distill and remove) methanol. Then, water was added therein.

Additionally, the temperature of the suspension was raised up to 70 to 90° C. to distill (distill and remove) methanol. Thus, an aqueous suspension of hydrophilic spherical silica particles was obtained.

### (II) Synthesis of Hydrophobic Spherical Colloidal Silica Particle 1

11.6 g of methyltrimethoxysilane was gradually added in the obtained aqueous suspension of hydrophilic spherical silica particles at room temperature dropwise for 0.5 hours. Even after finishing the dropping, hydrophobicity-imparting treatment was performed by further continuing 12-hour agitation.

1,440 g of methyl isobutyl ketone was added in the obtained suspension. Then, the temperature of the suspension was raised up to 80 to 110° C. to distill (distill and remove) an azeotropic mixture for 10 hours followed by cooling to room temperature.

1,000 g of methanol was added in the suspension obtained by distillation (distill and remove), and agitated for 10 minutes followed by being processed for 10 minutes at 3,000 G by means of a centrifuge to separate a supernatant liquid. Then, methyl isobutyl ketone and methanol being solvents were distilled from the residual liquid followed by drying. Thus, spherical colloidal silica particles were obtained.

With respect to 100 g of the spherical colloidal silica particles, 10 g of hexamethyldisilazane and 10 g of the compound represented by the above formula 3 being cyclic silazane were added as hydrophobicity-imparting treatment agents at room temperature. Then, the temperature was raised up to 110° C. and the reaction was performed for 3 hours. Thereby, the spherical colloidal silica particles were subjected to the hydrophobicity-imparting treatment.

Next, the mixture including the spherical colloidal silica particles was heated up to 80° C. under reduced pressure (6,650 Pa) to totally distill (distill and remove) the solvent. Thus, hydrophobic spherical colloidal silica particles 1 of Production example 1 were produced.

### Production Example 2

### (I) Synthesis of Hydrophilic Spherical Colloidal Silica Particle 2

Hydrophilic spherical colloidal silica particles 2 of Production example 2 were produced similarly as Production example 1 except that the added amount of tetramethoxysilane was changed to 1,105.0 g and the added amount of tetrabutoxysilane was changed to 121.6 g in Production example 1.

### (II) Synthesis of Hydrophobic Spherical Colloidal Silica Particle 2

Hydrophobic spherical colloidal silica particles 2 of Production example 2 were produced similarly as Production example 1 except that the cyclic silazane used as the hydrophobicity-imparting treatment agent was changed to 3-aminopropyltriethoxysilane in Production example 1.

### Production Example 3

### (II) Synthesis of Hydrophobic Spherical Colloidal Silica Particle 3

Hydrophobic spherical colloidal silica particles 3 of Production example 3 were produced similarly as Production example 1 except that the cyclic silazane was not used as the hydrophobicity-imparting treatment agent in Production example 1.

### Example 1

83 parts of styrene and 17 parts of n-butyl acrylate as monovinyl monomers (calculated Tg of copolymer to be obtained=60° C.), 7 parts of carbon black (product name: #25B; manufactured by Mitsubishi Chemical Corporation) as a black colorant, 1 part of a charge control resin having positively charging ability (product name: FCA-207P; manufactured by Fujikura Kasei Co., Ltd.; a styrene/acrylate resin) as a charge control agent, 0.6 parts of divinylbenzene as a crosslinkable polymerizable monomer, 1.9 parts of t-dodecyl mercaptan as a molecular weight modifier and 0.25 parts of polymethacrylic acid ester macromonomer (product name: AA6; manufactured by Toagosei Co., Ltd.; Tg of copolymer to be obtained=94° C.) as a macromonomer were agitated by means of an agitator to mix followed by uniform dispersion by means of a media type dispersing machine. Thereto, 5 parts of dipentaerythritol hexamyristate as a release agent was added, mixed and dissolved. Thus, a polymerizable monomer composition was obtained.

Separately, an aqueous solution of 6.2 parts of sodium hydroxide (alkali hydroxide metal) dissolved in 50 parts of ion-exchanged water was gradually added to an aqueous solution of 10.2 parts of magnesium chloride (water-soluble polyvalent metallic salt) dissolved in 250 parts of ion-exchanged water at room temperature while agitating to prepare a magnesium hydroxide colloid (hardly water-soluble metal hydroxide colloid) dispersion liquid.

The polymerizable monomer composition was charged into the magnesium hydroxide colloid dispersion liquid and agitated at room temperature. Then, 6 parts of t-butylperoxy-2-ethylhexanoate (product name: PERBUTYL O; manufactured by NOF Corporation) as a polymerization initiator was added therein. The mixture was subjected to a high shear agitation at 15,000 rpm for 10 minutes by means of an in-line type emulsifying and dispersing machine (product name: EBARA MILDER; manufactured by Ebara Corporation) to disperse. Thus, droplets of the polymerizable monomer composition were formed.

The suspension having droplets of the polymerization monomer composition dispersed (a polymerizable monomer composition dispersion liquid) was charged into a reactor furnished with an agitating blade and the temperature thereof was raised to 90° C. to start a polymerization reaction. When the polymerization conversion rate reached almost 100%, 1 part of methyl methacrylate as a polymerizable monomer for shell and 0.3 parts of 2,2′-azobis(2-methyl-N-(2-hydroxyethyl)-propionamide) (product name: VA-086; manufactured by Wako Pure Chemical Industries, Ltd.; water-soluble) being a polymerization initiator for shell dissolved in 10 parts of ion-exchanged water were added in the reactor. After continuing the reaction for 4 hours at 90° C., the reactor was cooled by water to stop the reaction. Thus, an aqueous dispersion of colored resin particles having a core-shell type structure was obtained.

The aqueous dispersion of the colored resin particles was subjected to acid washing in which sulfuric acid was added dropwise to be pH of 6.5 or less while agitating at room temperature. After separating by filtration, the aqueous dispersion of colored resin particles was subjected to water washing treatment (washing, filtration and dehydration) several times in which another 500 parts of ion-exchanged water was added to the thus obtained solid content to make a slurry again. Next, separation by filtration was performed and the thus obtained solid content was charged into a container of a dryer for drying at 45° C. for 48 hours. Thus, dried colored resin particles were obtained.

The volume average particle diameter “Dv” of the colored resin particles obtained was 9.7 rim, and the particle size distribution “Dv/Dn” was 1.14. The average circularity was 0.987.

To 100 parts of the colored resin particles, 0.7 parts of the hydrophobic spherical colloidal silica particle 1 produced in Production example 1 and 0.5 parts of a fumed silica particle (product name: TG-820F; manufactured by Cabot corporation; the number average primary particle diameter: 7 nm) subjected to surface treatment were added as external additives to mix and agitate by means of a high speed agitator (product name: Henschel Mixer; manufactured by NIPPON COKE & ENGINEERING CO., LTD.) at a peripheral speed of 30 m/s for 6 minutes, and the external additives were externally added. Thus, a toner of Example 1 was produced, and used for printing test.

### Example 2

A toner of Example 2 was produced similarly as Example 1 except that the added amounts of the spherical colloidal silica particle, and the fumed silica particle in Example 1 were changed to 1 part and 0.3 parts respectively, and was used for printing test.

### Example 3

A toner of Example 3 was produced similarly as Example 1 except that 0.1 parts of zinc stearate particle (product name: SFZ-100F; manufactured by Sakai Chemical Industry Co., Ltd.; the number average primary particle diameter: 0.45 μm) being fatty acid metal salt particle was added as another external additive with respect to 100 parts by weight of the colored resin particle in Example 1, and was used for printing test.

### Comparative Example 1

A toner of Comparative example 1 was produced similarly as Example 1 except that the kind of the spherical colloidal silica particle in Example 1 was changed to hydrophobic spherical colloidal silica particles 2 produced in Production example 2, and was used for printing test.

### Comparative Example 2

A toner of Comparative example 2 was produced similarly as Example 1 except that the spherical colloidal silica particle was not used and 0.7 parts of NA50Y (product name; manufactured by Nippon Aerosil Co., Ltd.; the number average primary particle diameter: 35 nm) being a fumed silica particle subjected to surface treatment was further added besides the fumed silica particle in Example 1, and was used for printing test.

### Comparative Example 3

A toner of Comparative example 3 was produced similarly as Example 1 except that the kind of the spherical colloidal silica particle in Example 1 was changed to the hydrophobic spherical colloidal silica particles 3 produced in Production example 3, and was used for printing test.

### Comparative Example 4

A toner of Comparative example 3 was produced similarly as Example 1 except that the kind of the fumed silica particle in Example 1 was changed to NA50Y (product name; manufactured by Nippon Aerosil Co., Ltd.; the number average primary particle diameter: 35 nm) subjected to surface treatment, and was used for printing test.

### (Results)

The test results of Examples and Comparative examples are shown in Tables 1-1 and 1-2.

Remarks in Table 1-1 are as follows. *1: Silica 1 (the hydrophobic spherical colloidal silica particle 1 produced in Production example 1), Silica 2 (the hydrophobic spherical colloidal silica particle 2 produced in Production example 2), and Silica 3 (the hydrophobic spherical colloidal silica particle 3 produced in Production example 3)

TABLE 1-1

| | | | |
|---|---|---|---|
| | | | Comparative |
| Example 1 | Example 2 | Example 3 | example 1 |

(External additives)

| | | | | | |
|---|---|---|---|---|---|
| Spherical colloidal | Type *1 | Silica 1 | Silica 1 | Silica 1 | Silica 2 |
| silica particles | Surface treatment | Cyclic silazane + | Cyclic silazane + | Cyclic silazane + | 3-aminopropyl- |
| | agent | Hexamethyl- | Hexamethyl- | Hexamethyl- | triethoxysilane |
| | | disilazane | disilazane | disilazane | |
| | Number average | 70 | 70 | 70 | 100 |
| | primary particle | | | | |
| | diameter (nm) | | | | |
| | Triboelectric charge | 190 | 190 | 190 | 23 |
| | amount (μC/g) | | | | |
| | Loose apparent bulk | 0.265 | 0.265 | 0.265 | 0.584 |
| | density (g/ml) | | | | |
| | Added amount (part) | 0.7 | 1 | 0.7 | 0.7 |
| Fumed silica | Type | TG-820F | TG-820F | TG-820F | TG-820F |
| particles | (manufacturer) | (Cabot) | (Cabot) | (Cabot) | (Cabot) |
| | Number average | 7 | 7 | 7 | 7 |
| | primary particle | | | | |
| | diameter (nm) | | | | |
| | Loose apparent bulk | 0.07 | 0.07 | 0.07 | 0.07 |
| | density (g/ml) | | | | |
| | Added amount (part) | 0.5 | 0.3 | 0.5 | 0.5 |
| Fatty acid | Type | — | — | Zinc stearate | — |
| metal salt | | | | particle | |
| particles | Added amount (part) | — | — | 0.1 | — |

| | | |
|---|---|---|
| Comparative | Comparative | Comparative |
| example 2 | example 3 | example 4 |

(External additives)

| Spherical colloidal | Type *1 | — | | Silica 3 | Silica 1 |
|---|---|---|---|---|---|
| silica particles | Surface treatment | — | | Hexamethyl- | Cyclic silazane + |
| | agent | | | disilazane | Hexamethyl- |
| | | | | | disilazane |
| | Number average | — | | 70 | 70 |
| | primary particle | | | | |
| | diameter (nm) | | | | |
| | Triboelectric charge | — | | −200 | 190 |
| | amount (μC/g) | | | | |
| | Loose apparent bulk | — | | 0.33 | 0.265 |
| | density (g/ml) | | | | |
| | Added amount (part) | — | | 0.7 | 0.7 |
| Fumed silica | Type | TG-820F | NA50Y | TG-820F | NA50Y |
| particles | (manufacturer) | (Cabot) | (Nippon Aerosil) | (Cabot) | (Nippon Aerosil) |
| | Number average | 7 | 35 | 7 | 35 |
| | primary particle | | | | |
| | diameter (nm) | | | | |
| | Loose apparent bulk | 0.07 | 0.08 | 0.07 | 0.08 |
| | density (g/ml) | | | | |
| | Added amount (part) | 0.5 | 0.7 | 0.5 | 0.5 |

| | | | | |
|---|---|---|---|---|
| Fatty acid | Type | — | — | — |
| metal salt | Added amount (part) | — | — | — |
| particles | | | | |

TABLE 1-2

| | | | | | | |
|---|---|---|---|---|---|---|
| | | | Comparative | Comparative | Comparative | Comparative |
| Example 1 | Example 2 | Example 3 | example 1 | example 2 | example 3 | example 4 |

(Colored resin particles)

| | | | | | | | |
|---|---|---|---|---|---|---|---|
| Average circularity | 0.987 | 0.987 | 0.987 | 0.987 | 0.987 | 0.987 | 0.987 |

(Printing test)

| | | | | | | | |
|---|---|---|---|---|---|---|---|
| Blade fixing (N/N) | S | S | S | M | L | M | L |
| Reproductivity of thin lines | 10,000< | 10,000< | 10,000< | 10,000< | 5,500 | 6,500 | 6,500 |
| (print) (N/N) | | | | | | | |
| Printing durability (print) | 11,000 | 11,000 | 15,000< | 6,000 | 7,500 | 5,000 | 6,000 |
| (N/N) | | | | | | | |
| Printing durability (print) | 6,500 | 6,500 | 6,500 | 4,500 | 4,500 | 3,500 | 4,500 |
| (H/H) | | | | | | | |
| Number of prints having fog | 3 | 4 | 3 | 15 | 25 | 30 | 20 |
| disappearance soon after | | | | | | | |
| replenishment of toner | | | | | | | |
| (print) (N/N) | | | | | | | |

### (Summary of Results)

The following can be found from the test results shown in Tables 1-1 and 1-2.

In the toner of Comparative example 1, the reproductivity of thin lines was excellent, however, it took time to eliminate the fog generated upon the initial printing soon after replenishment of the toner, and the printing durability was inferior, since the toner of Comparative example 1 used the spherical colloidal silica particle, the particle diameter of which was not within the range specified in the present invention, as the external additive.

Also, in the toner of Comparative example 2, it took time to eliminate the fog generated upon the initial printing soon after replenishment of the toner, the reproductivity of thin lines was poor, and the printing durability was inferior, since the toner of Comparative example 2 did not use the spherical colloidal silica particle as the external additive.

In the toner of Comparative example 3, it took time to eliminate the fog generated upon the initial printing soon after replenishment of the toner, the reproductivity of thin lines was poor, and the printing durability was inferior, since the toner of Comparative example 3 used the spherical colloidal silica particle, the triboelectric charge amount of which was not within the range specified in the present invention, as the external additive.

Also, in the toner of Comparative example 4, it took time to eliminate the fog generated upon the initial printing soon after replenishment of the toner, the reproductivity of thin lines was poor and the printing durability was inferior, since the toner of Comparative example 4 used the fumed silica particle, the particle diameter of which was not within the range specified in the present invention, as the external additive.

To the contrary, in the toners of Examples 1 to 3, the fog generated upon the initial printing soon after replenishment of the toner was promptly eliminated, and both reproductivity of thin lines and printing durability were excellent, since the toners of Examples 1 to 3 used the specific amounts of the spherical colloidal silica particle and the fumed silica particle specified in the present invention as external additives. Particularly, the toner of Example 3 was further excellent in printing durability, since the toner of Example 3 also used the fatty metal salt particle as the external additive.

1. A positively-chargeable toner for developing electrostatic images comprising a colored resin particle containing a binder resin and a colorant, and external additives,
wherein a spherical colloidal silica particle having a number average primary particle diameter of 30 to 80 nm and a triboelectric charge amount of −50 to +300 μC/g, and a fumed silica particle having a number average primary particle diameter of 5 to 25 nm are contained as the external additives, and
wherein a content of the spherical colloidal silica particle is in the range from 0.3 to 2 parts by weight and a content of the fumed silica particle is in the range from 0.1 to 1 part by weight with respect to 100 parts by weight of the colored resin particle.

2. The positively-chargeable toner for developing electrostatic images according to claim 1, wherein loose apparent bulk density of the spherical colloidal silica particle is in the range from 0.15 to 0.35 g/ml.

3. The positively-chargeable toner for developing electrostatic images according to claim 1, wherein loose apparent bulk density of the fumed silica particle is in the range from 0.01 to 0.1 g/ml.

4. The positively-chargeable toner for developing electrostatic images according to claim 1, wherein the spherical colloidal silica particle and the fumed silica particle are external additives subjected to surface treatment by at least cyclic silazane.

5. The positively-chargeable toner for developing electrostatic images according to claim 1, wherein 0.01 to 0.5 parts by weight of a fatty acid metal salt particle is further contained as the external additive with respect to 100 parts by weight of the colored resin particle.

6. The positively-chargeable toner for developing electrostatic images according to claim 1, wherein an average circularity of the colored resin particle is 0.975 or more.

7. An image forming method using the positively-chargeable toner for developing electrostatic images defined by any of claims 1 to 6.

8. The image forming method according to claim 7, wherein the image forming method is a cleanerless method.
